(19) United States
(12) Patent Application Publication
(10) Pub. No.: US 2026/0234450 A1
(43) Pub. Date: Aug. 13, 2026

(54) COMPOSITIONS OF CHITIN AND HYDROPHILIC AND/OR LIPOPHILIC WAX, COMPOSITIONS OF CHITIN AND CELLULOSIC MATERIAL, AND RELATED METHODS FOR PRODUCING SAME

(71) Applicant: Neptune Nanotechnologies Inc., Markham (CA)

(72) Inventor: Sarswati Koul, Markham (CA)

(73) Assignee: Neptune Nanotechnologies Inc., Markham, ON (CA)

(21) Appl. No.: 19/470,682

(22) PCT Filed: Apr. 2, 2024
(86) PCT No.: PCT/CA2024/050422

§ 371 Date: Sep. 29, 2025

Related U.S. Application Data
(60) Provisional application No. 63/456,087, filed on Mar. 31, 2023.

(51) Int. Cl. C09J 171/02; C08L 71/02

(52) U.S. Cl. CPC C09J 171/02; C08L 71/02; C08L 2205/00; C09J 2405/006; C09J 2471/006

(57) ABSTRACT

Described herein are composites and mixtures comprising chitin and a hydrophilic and/or lipophilic polymer wax, and various uses thereof. Also described herein are self-supporting structures comprising molded and dried cellulose-based slurries having chitin generally uniformly distributed throughout. Also described are methods of forming a self-supporting structure, including: providing a cellulose-based slurry; distributing chitin generally uniformly throughout the cellulose-based slurry thereby to form a modified cellulose-based slurry; and molding the self-supporting structure using the modified cellulose-based slurry. Also described are self-supporting structures comprising chitin generally uniformly distributed about at least a surface of a respective cellulose-based structure.

### CROSS-REFERENCE TO RELATED APPLICATION

This application claims priority to U.S. Provisional Patent Application Ser. No. 63/456,087 entitled “COMPOSITIONS OF NANO-CHITIN AND HYDROPHILIC AND/OR LIPOPHILIC WAX” filed on Mar. 31, 2023, the contents of which are incorporated herein by reference.

### FIELD OF THE INVENTION

The present disclosure relates generally to nanocomposites and more particularly to chitin nanocomposites and methods of fabricating same.

### BACKGROUND OF THE INVENTION

Nanoparticles are particles having one or more dimensions between 1 and 100 nanometers (nm). Due primarily to a high percentage of their atoms being positioned at the surface providing a very large surface area for their size, nanoparticles of a given material can exhibit markedly different properties and behaviours than larger particles of the same material.

Nanocomposites are multiple-phase materials, found in nature or fabricated, where one of the phases is nanoparticles. For example, a solid nanocomposite comprises nanoparticles dispersed in a bulk solid matrix. Due to the unique physical properties of nanoparticles, a small percentage of nanoparticles can have noticeable, macro-scale effects on the bulk solid matrix. As such, fabrication of nanocomposites having nanoparticles for imparting beneficial macro-scale mechanical, electrical, optical, dielectrical, thermal, antimicrobial or other effects is of great interest.

Nanofibrils, or nanowhiskers, are nanoparticles having a crystalline rod-like structure.

Chitin is an abundant, biodegradable and non-toxic structural polysaccharide material that can be extracted from crustaceans such as shrimp and crab. Chitin nanowhiskers, including crystalline polysaccharides having a diameter of about 10 nm and a length of about 200 nm to about 500 nm, may be found in extracted chitin. Chitin nanowhiskers are desirable for nanocomposites due to their ability to impart desirable mechanical and antimicrobial effects, as well as due to their biodegradability, their abundance and their non-toxicity.

In nature, chitin contains both amorphous and crystalline chitin along with various other components such as proteins and the like. For forming nanocomposites, it has been indicated as desirable to extract mostly individual chitin nanowhiskers from chitin so that the individual nanowhiskers can be dispersed throughout a bulk matrix. As such, it has been desirable to process the chitin to generally extract only individual chitin nanowhiskers, without also extracting agglomerated chitin nanowhiskers that can be undesirably larger in size, amorphous chitin, and the proteins or other materials.

While individual chitin nanowhiskers are certainly desirable for certain nanocomposites, other composites, mixtures, and products comprising chitin may be desirable.

### SUMMARY OF THE INVENTION

This document outlines some parameters of experiments and studies embarked upon to discover more about the various phenomena that arise when various forms of chitin, cellulosic materials such as paper, and hydrophilic and/or lipophilic polymer wax such as Carbowax PEG-8000, are brought together in various combinations and in respective forms.

In accordance with an aspect, there is provided a composite comprising chitin nanocrystals dispersed in a hydrophilic and/or lipophilic polymer wax.

In accordance with an aspect, there is provided a composite comprising chitin dispersed in a hydrophilic and/or lipophilic polymer wax.

In an embodiment, the chitin is substantially non-agglomerated.

In an embodiment, the chitin comprises units of substantially non-agglomerated chitin and units of agglomerated chitin.

In an embodiment, the chitin is dispersed generally uniformly throughout the hydrophilic and/or lipophilic polymer wax.

In an embodiment, the hydrophilic and/or lipophilic polymer wax is in solid form at room temperature.

In an embodiment, the hydrophilic and/or lipophilic polymer wax is in flake or powder form.

In an embodiment, the hydrophilic and/or lipophilic polymer wax is in liquid form.

In an embodiment, the hydrophilic and/or lipophilic polymer wax is a polyethylene glycol.

In accordance with an aspect, there is provided a use of the composite as a binding agent.

In accordance with an aspect, there is provided a binding agent comprising chitin dispersed in a hydrophilic and/or lipophilic polymer wax.

In accordance with an aspect, there is provided a method of forming a composite, comprising the steps described herein.

In accordance with an aspect, there is provided a composite formed by the method of claim 12.

In accordance with an aspect, there is provided a mixture comprising chitin and at least one hydrophilic and/or lipophilic polymer wax.

In an embodiment, the mixture consists of chitin dispersed in the at least one hydrophilic and/or lipophilic polymer wax.

In an embodiment, the mixture comprises chitin dispersed in a solution comprising at least one hydrophilic and/or lipophilic polymer wax.

In an embodiment, the solution further comprises at least one of water and an ionic liquid.

In an embodiment, the at least one hydrophilic and/or lipophilic polymer wax is polyethylene glycol (“PEG”).

In an embodiment, the at least one hydrophilic and/or lipophilic polymer wax is Carbowax PEG-8000.

In accordance with an aspect, there is provided a use of the mixture as a binding agent.

In accordance with an aspect, there is provided an adhesive comprising chitin nanocrystals dispersed in a hydrophilic and/or lipophilic polymer wax.

In accordance with an aspect, there is provided a method of forming a self-supporting structure, the method comprising: providing a cellulose-based slurry; distributing chitin generally uniformly throughout the cellulose-based slurry thereby to form a modified cellulose-based slurry; and molding the self-supporting structure using the modified cellulose-based slurry.

In an embodiment, prior to the distributing chitin step, the chitin is encapsulated within a hydrophilic and/or lipophilic polymer wax thereby to form a chitin-wax composite, wherein the distributing chitin step comprises distributing the chitin-wax composite generally uniformly throughout the cellulose-based slurry.

In accordance with an aspect, there is provided a self-supporting structure formed using the method.

In accordance with an aspect, there is provided a self-supporting structure comprising: a molded and dried cellulose-based slurry having chitin generally uniformly distributed throughout.

In an embodiment, the self-supporting structure further comprises: a hydrophilic and/or lipophilic polymer wax generally uniformly distributed throughout.

In accordance with an aspect, there is provided a self-supporting structure comprising chitin generally uniformly distributed about at least a surface of a cellulose-based structure.

In an embodiment, the chitin is generally uniformly distributed throughout the cellulose-based structure.

Various examples are described.

### BRIEF DESCRIPTION OF THE FIGURES

Examples will now be described more fully with reference to the accompany drawings, in which:

FIG. 1A is an image of two experiment trays each containing a respective solution of tap water and a chitin-Carbowax composite, and each coating two pieces of paper;

FIG. 1B is an image of four experiment trays each containing a respective solution of tap water and a chitin-Carbowax composite, two of the trays with the presence of an ionic liquid and two of the trays without;

FIG. 2A shows an overlapping and binding of two pieces of paper following immersion of the two pieces of paper in the solution of tap water and a chitin-Carbowax composite;

FIG. 2B shows an overlapping and binding of two other pieces of paper following immersion of the two pieces of paper in the solution of tap water and a chitin-Carbowax composite;

FIG. 3A shows strips of polyethylene films coated, respectively, with pure 10%, 30%, and 50% solutions of just Carbowax (no chitin) and tap water;

FIG. 3B shows strips of white and brown paper coated, respectively, with pure 10%, 30%, and 50% solutions of just Carbowax (no chitin) and tap water;

FIG. 3C shows strips of polyethlene films, white paper pieces, and brown paper pieces each coated, respectively, with 2% solutions of chitin-Carbowax composites and tap water;

FIG. 4A shows an experiment dish with a piece of paper only coated with Carbowax;

FIG. 4B shows an experiment dish with a piece of paper having been coated with a chitin-Carbowax coating for 27 days at room temperature, showing an amount of bio-degradation; and

FIG. 4C shows the experiment dish of FIG. 4B with the piece of paper having been coated with the chitin-Carbowax coating for 67 days at room temperature, showing a further amount of bio-degradation.

### DETAILED DESCRIPTION OF THE EXAMPLES

Compositions of nano-chitin and hydrophilic and/or lipophilic polymer wax such as Carbowax™ (“Carbowax”) have surprisingly been found to demonstrate adhesion qualities, with the properties and magnitudes of such adhesion qualities not appearing to be available from either of these constituents alone. It will be appreciated that adhesion qualities of such compositions may be useful in many applications, and auxiliary benefits may accrue.

### Experimental Procedure for Carbowax-Encapsulated Nanochitin Material

In this section, a detailed experimental procedure for investigating compatibilities between different mixtures, (or “composites”), of Carbowax and nanochitin whiskers is explained. Carbowax is a trade name used by Dow Chemical™ for its series of polyethylene glycol, or “PEG”, products. PEG is very well known and has many applications in many different industries.

Experimental procedures were conducted for each of three different types of nanochitin crystalline filler materials, separately combined with a particular hydrophilic and/or lipophilic polymer wax. For all, the particular wax was a particular Carbowax. The three different types of nanochitin crystalline filler materials were:
(1) chitin nanocrystals resulting from (i.e., products of) a hydrolysis process conducted on raw chitin, such as the hydrolysis process described in U.S. Pat. No. 9,169,376 to Guan, the contents of which are incorporated herein by reference.
(2) chitin nanocrystals prepared using a process involving an ionic liquid, as described in commonly-owned PCT (International) Patent Application Publication No. WO/2024/031186 to Guan entitled “SOLVENT SYSTEMS AND METHODS FOR PROCESSING CHITIN”, the contents of which are incorporated herein by reference.
(3) chitin particles left over from (i.e., byproducts of) a hydrolysis process conducted on raw chitin such as that in (1), in particular a micro-particle mixture of both crystalline chitin and amorphous chitin, or nanochitin “waste” material. Otherwise referred-to herein as hydrolyzed chitin.

Therefore, the experimental procedure was conducted by varying only the nature/quality of the chitin nanowhiskers, with the wax being constant.

A) Experimental Procedure for Carbowax PEG-8000 Encapsulating Nanochitin Crystalline Whiskers without Ionic Liquid (or, as it is Referred to Herein: “Default Grade” Nanochitin Crystalline Whiskers)

The first experimental work was carried out with Carbowax PEG-8000, and nanochitin crystalline whiskers prepared in the lab by using an acid hydrolysis method, and alternatively used a method as described in the above-cited '186 patent application.

Initially, 10 gms (grams) of Carbowax PEG-8000 was dissolved in water at 600° C. (degrees Celsius) in a beaker with constant mixing on a hot plate. This Carbowax-water solution was left on the magnetic heating plate until it formed a substantially visually-clear solution. At this time, 10 gms of nanochitin crystalline whiskers (in a liquid phase as a result of preparation using, separately, the methods referred-to above) was slowly and periodically added to the visually-clear Carbowax-water solution. The temperature was then raised to 1000° C. until a substantially homogenous nanochitin-Carbowax-water solution was obtained. This homogenous solution was then fully covered, and was left to be constantly stirred at 1200° C. for a period of between about 2 and about 4 hours. The final product—by this time a thick paste—was then collected and placed in an oven for drying at a temperature range of between 1100° C. to 1600° C. After complete drying in the oven, the material was collected and grounded into a fine white-yellow powder. This fine white-yellow powder was then separately tested for: solubility, homogeneity, adhesion and moisture sensitivity.

The fine white-yellow powder appeared to offer better water solubility than pure nanochitin waste material at room temperature, good homogeneity and demonstrated resistance to the moisture content at room temperature. For example, resistance to moisture was measured by leaving the powder at room temperature in an open dish for different periods: a period of 24 hours, a period of 48 hours and a period of five days. It was observed that, for all of these periods the powder, did not substantially manifest any observable gains in weight, nor did it substantially manifest any observable changes in surface texture or feel. It was also observed visually that the powder appeared to be resistant to moisture content.

It is to be noted that initial experimental work was performed with the equi-weight (by weight) ratio between the two reactants (Carbowax PEG-8000 and default grade nanochitin crystalline whiskers). However, further experimental procedures were also carried out using various ratios of Carbowax PEG-8000 to default grade nanochitin crystalline whiskers. For example, the Carbowax PEG-8000:nanochitin whisker ratios were prepared at each of (1:0.5), (1:0.7) and (1:0.3). In particular, in experiments using these alternative ratios, only the weight of nanochitin whiskers was changed such that the weight amount of Carbowax PEG-8000 was kept constant. Visually there was not much difference in the powder forms as between these differing ratios. However, there was observed to be differences in solubility.

Furthermore, it was observed that decreasing the relative amount of Carbowax PEG-8000 content did not substantially affect the adhesion mechanism, as will be explained in more detail below. That is, it appears that it is actually the nanochitin whisker contents themselves that effect an adhesion property (see below). As reinforcement for this observation, these experiments demonstrated that the lesser the amount of nanochitin whiskers, the longer it can take for an occurrence of a “self-adhesion”—or what may be regarded as a “mutual adhesion”—of two initially separate pieces of paper that have been placed in proximity with one another encapsulated by a liquid composition (of tap water and the white-yellow powder mixed together and subjected to temperature of 80° C. to 100° C.) and placed in proximity with one another. This was based on visual observation.

Further experimentation was conducted using compositions differing by the weight of Carbowax-8000 but keeping the concentration of Nanochitin Whiskers without ionic liquids constant. Compositions with a presence of ionic liquid were also experimented with. This aided our understanding of how the adhesion property, as well as chemical and physical properties vary from composition to composition. Generally-speaking, it appears that, while the ionic liquid can be used to produce higher-quality, or high purity grade, chitin, the ionic liquid itself has not been observed to directly influence adhesion properties themselves.

### B) Experimental Procedure for Carbowax PEG-8000 Encapsulating Nanochitin Crystalline Whiskers in the Presence of an Ionic Liquid (or, as it is Referred to Herein: “High Purity Grade” Nanochitin Crystalline Whiskers)

For this experiment, the ionic liquid was 1-ethyl-3-methylimidozolium acetate, and the same experimental approach as that explained above in connection with (A) was applied.

For this second kind of composition as well, all of the initial experimental work was performed with the equi-weight (by weight) ratio between the two materials (Carbowax PEG-8000 and high purity grade nanochitin crystalline whiskers. But the experimental procedure was also carried out between various ratios of Carbowax PEG-8000 and high purity grade nanochitin crystalline whiskers, where the ratios (1:0.5), (1:0.7) and (1:0.3) were used. That is, in these experiments only the weight of high purity grade nanochitin crystalline whiskers was changed while the amount of Carbowax PEG-8000 was kept constant by weight.

Experiments for these composition were conducted, in which the weight of Carbowax-8000 was changed and the concentration of Nanochitin Whiskers without ionic liquids was kept constant. This was done to more fully understand how the adhesion property, chemical and physical properties vary from composition to composition. It was generally found that using the waste grade chitin in the compositions manifested greater adhesion than did use of either the default grade or high purity grade chitin.

### C) Experimental Procedure for Carbowax PEG-8000 Encapsulating Nanochitin Waste Whiskers

As explained herein, nanochitin waste whiskers are the waste material or byproduct collected after hydrolysis and a centrifuging step during which crystalline and amorphous phase gets separated. It is therefore the case that nanochitin waste whiskers may have a high concentration of amorphous phase chitin.

We wanted to try various things in an effort to study how the “self” or “mutual” adhesion behavior of paper, as referenced above, may vary for the nanochitin waste whiskers, as compared with the default grade and high purity grade nanochitin crystalline whiskers. The same approach as mentioned above was being applied here as well. It is to be noted that, with the waste material (i.e. the hydrolyzed chitin), the experimental work was performed using the constituents in the (1:1) and (1:0.5) ratios, where the amount of Carbowax PEG-8000 was kept constant and the amount of nanochitin was changed.

Additional tests were conducted using constituents in the (0.5:1) and (0.3:1) ratios. Furthermore, similar tests were conducted with other members from the Carbowax series (in particular, Carbowax-3000, Carbowax-600, and Carbowax-400 were of interest), differing in their molecular weight in order to observe whether there were any changes in physical properties and in adhesion behaviors. Limited results are available at this time from these other, lower molecular weight Carbowax products. Our initial consideration in beginning experiments with the higher molecular weight Carbowax PEG-8000 was to observe the compatibility and structural stability of the Carbowax when encapsulating nanochitin crystalline whiskers. At lower concentration of Carbowax within the formulation, properties were dominated by Chitin waste material and the adhesive properties were found similar to that when compared with controlled Chitin waste material.

Observations indicated that the molecular weight of Carbowax plays an important role in achieving balanced adhesion. However, it has been found that it is mainly the nanochitin waste that allows the encapsulation capacity to hold these wax particles with prolonged adhesiveness and good dispersibility. It is possible that this is because high purity grade chitin nanocrystals may simply present less actual chitin than waste grade chitin may tend to do. Results with a wide variety of Carbowax series are not available, though it may be predicted on the basis of the similarities in chemistry that behaviors from Carbowax-8000 may enable derivation of similar behaviors using lower molecular weight ones in this series. Carbowax with different molecular weight showed similar water solubility threshold, indicating that final properties will not have much difference when the formulations were prepared in combination with nano chitin waste whiskers. Hence, the rest of the experimental work was done with the Carbowax PEG-8000 series only.

It is expected that other materials that may be considered hydrophilic and lipophilic waxes may be usable in place of Carbowax specifically. Examples may include Elin care Hydro lipophilic wax (Green Apple Cream Wax) and Elin care Hydro lipophilic wax (Chocolate wax). We have not done any experiment with above mentioned materials, because Carbowax itself may be regarded as hydrophilic and lipophilic, while some grades of Carbowax is hydrophobic as well. We started with the Carbowax PEG-8000 series as it offers a balance between hydrophilic and hydrophobic content. Indeed some lower molecular weight water soluble waxes will be used in future experiments. Structurally and technically the results are expected to differ in some regards.

### Analytical Tests Required to Support the Initial Data:—

1. TGA/DSC (which will show the encapsulation behavior)
2. SEM/AFM (Surface Morphology)
3. Adhesion testing (ASTM)

It will be appreciated that the compositions described herein are, at this time, biobased such that the adhesive can be coated as a biodegradable adhesive system.

Table 1 below offers an overview about the experimental reactant ratios that were being used to form final products. In the table, only experiments with equivalent weight are reported. However, experiments were indeed performed using various ratios to observe the effect of reactant ratios on each other as well as on the final yield quotient. Based on the difference in weight proportions, the final product shows a difference in final reaction yield quotient indeed. No big difference was observed in adhesion property. While looking under the lab microscope, a difference in morphology was observed. An explanation for the behavior as seen at this lower magnification is that there is an interaction between crystalline chitin and the Carbowax through hydrogen bonding, which effectively enhances the encapsulation behavior, resulting in formation of a compatible system.

TABLE 1

| | | Theoretical Yield As | |
|---|---|---|---|
| | | Calculated on basis | |
| | | of assumption, if | |
| | | everything reacts at | |
| | Starting Reactant | molecular level, the | Final Reactions |
| Experimental Composition | Weight By Grams | yield must be 100% | Reaction Yield (%) |
| Carbowax PEG-8000 + default | 10 gms of | 100% (assumed) | 92.25% (this ratio |
| grade nanochitin crystalline | Carbowax PEG- | | was being calculated |
| whiskers | 8000 + 10 gms of | | after the weighing the |
| | nanochitin | | total product |
| | whiskers prepared | | formation) |
| | in lab | | |
| Carbowax PEG -8000 (10 gms) + | 10 gms of | 100% (assumed) | 64.12% (this ratio |
| high purity grade nanochitin | Carbowax PEG- | | was being calculated |
| crystalline whiskers (ionic | 8000 + 10 gms of | | after the weighing the |
| liquid: 1-ethyl-3- | nanochitin | | total product |
| methylimidozolium acetate) | whiskers prepared | | formation) |
| | in lab | | |
| Carbowax PEG-8000 (10 gms) + | 10 gms of | 100% (assumed) | 94.5% (this ratio was |
| nanochitin waste whiskers | Carbowax PEG- | | being calculated after |
| collected after hydrolysis + | 8000 + 10 gms of | | the weighing the total |
| centrifuge. In particular, | waste whiskers. | | product formation) |
| after dialysis the | | | This product was |
| nanochitin crystalline whiskers | | | very thick and |
| were separated from | | | required slow heating |
| amorphous ones using a | | | for drying the final |
| centrifuge. The crystalline | | | product. A very thick |
| parts are regarded as default | | | and paste-like |
| grade and the primarily | | | material compared to |
| amorphous parts are regarded | | | the above-listed |
| as waste. It is the waste | | | compositions in the |
| material that was subjected to | | | table. |
| encapsulation by Carbowax | | | |
| PEG-8000 in this composition. | | | |

### Uses of Compositions for “Self-Adhesion” or “Mutual-Adhesion” of Paper Pieces

### Coating Property and Self-Adhesion Property Evaluation

Initial lab experimental work showed good adhesion and self binding properties. In particular, the compositions were used to bind pieces of plain white paper (printing paper) with each other, and pieces of brown paper (packaging paper just collected from within the lab) with each other. The grade for brown paper is not specified herein but is what is commonly available as packaging material.

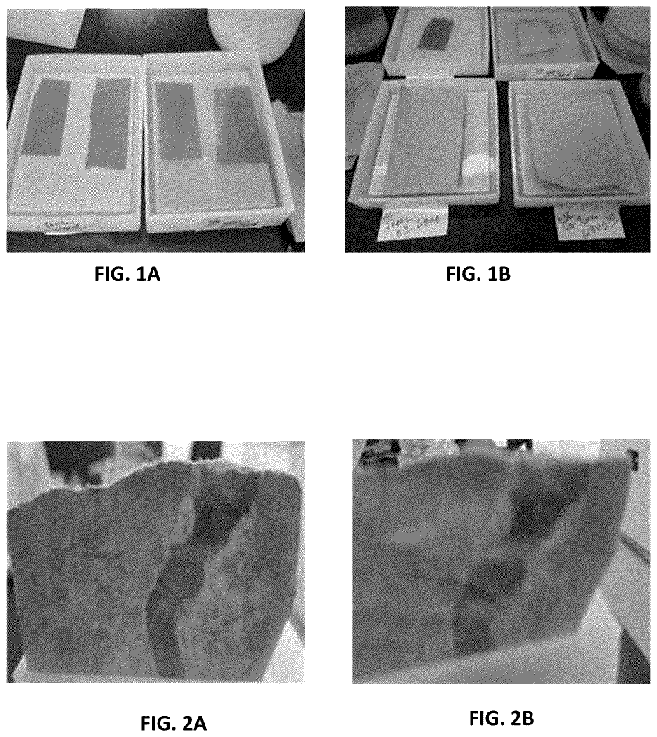

FIG. 1A is an image of two experiment trays each containing a respective solution of tap water and a chitin-Carbowax composite, and each coating two pieces of paper. FIG. 1B is an image of four experiment trays each containing a respective solution of tap water and a chitin-Carbowax composite, two of the trays with the presence of an ionic liquid and two of the trays without.

First Coating Trial on Brown Paper (BP); Coating Made with Carbowax PEG-8000 Encapsulated with Nanochitin Crystalline Whiskers Either of Default Grade or of High Purity Grade.

The whole procedure involves first drying the paper pieces in an oven at 550° C., to remove any moisture from the paper pieces, followed by the coating of these paper pieces with the solutions obtained from (a) Carbowax PEG-8000 encapsulated nanochitin crystalline whiskers of default grade and (b) Carbowax PEG-8000 encapsulated nanochitin crystalline whiskers of high purity grade in tap water. For all the preliminary experimental work, 1%, 2% and 5% solutions were used to coat the paper pieces. Coating was done by dipping the paper pieces in 1%, 2% and 5% solutions. These paper pieces were then dried in an oven for a period of two hours. Following drying, a gain in weight was observed, indicating that the coating has some chemical interaction with contents, in particular the cellulose contents, present within the paper pieces. These paper pieces were dipped again in water for a period of 40 minutes, to observe and then prove that the coating was retained by the surfaces of the paper pieces.

An observation indicated that paper pieces coated with the ionic liquid was consistent with the weight while paper coated with Carbowax encapsulated Nanochitin crystals, having no ionic liquids offered a difference in loss of weight of 10%, indicating the loss may be due to chemical interaction leaching. That is, what was found when the paper was coated first with ionic liquid alone, followed by the nanochitin coating (either default grade or high purity grade or waste grade) on the paper, was that there is a loss of adhesion as well as coating from the substrate, as compared with the paper when it is not previously coated with the ionic liquids. This appears to indicate that the presence of ionic liquids promotes an adhesion between the cellulose and chitin. On the other hand, when the coating is without the ionic liquids, there is a loss of coating over a period of time.

The coating behavior showed a very good self-adhesion property and this was evaluated that separately as below.

FIG. 2A shows an overlapping and binding of two pieces of paper following immersion of the two pieces of paper in the solution of tap water and a chitin-Carbowax composite. FIG. 2B shows an overlapping and binding of two other pieces of paper following immersion of the two pieces of paper in the solution of tap water and a chitin-Carbowax composite.

First Self-Adhesion Property of Carbowax encapsulated with Nanochitin Crystalline Whiskers on Brown paper showing good self-adhesion. When Carbowax encapsulated with Nanochitin whiskers treated with ionic liquid were dissolved in tap water (2 gms in 10 ml of tap water) and then two piece of paper were dipped in the above mentioned water-based solution, the two pieces of paper were then left at room temperature condition for a period of 2-3 hours. The papers exhibited better adhesion and self-locking mechanism without applying any external heat and pressure.

To prove that the adhesion is an intrinsic property and is being attributed to the paper through Carbowax encapsulated Nanochitin crystal whiskers, a comparative experiment was carried where first polyethylene films and papers were coated with pure Carbowax solutions prepared by using different amounts of Carbowax-8000 in presence of a Tap water. Whereas the comparison towards adhesion property was measured by using:

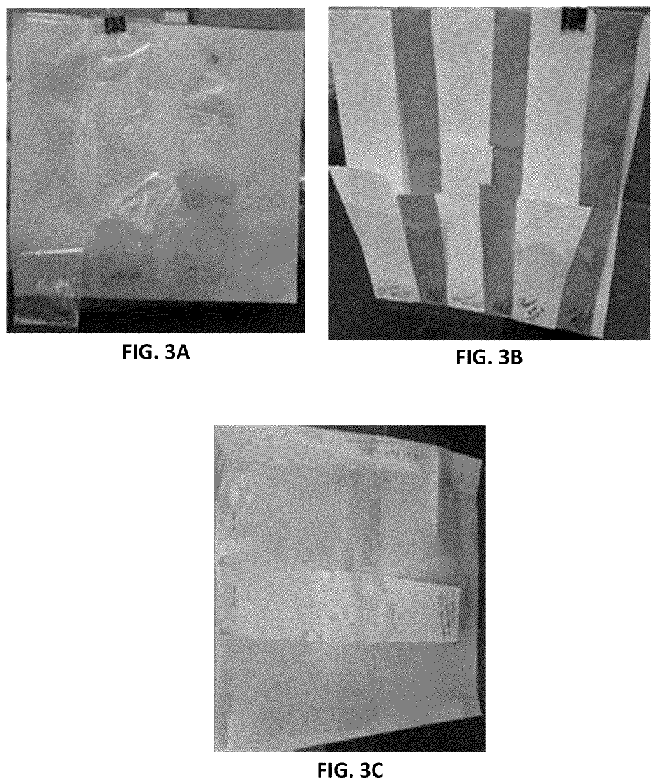

FIG. 3A shows strips of polyethylene films coated, respectively, with pure 10%, 30%, and 50% solutions of just Carbowax (no chitin) and tap water. FIG. 3B shows strips of white and brown paper coated, respectively, with pure 10%, 30%, and 50% solutions of just Carbowax (no chitin) and tap water. FIG. 3C shows strips of polyethylene films, white paper pieces, and brown paper pieces each coated, respectively, with 2% solutions of chitin-Carbowax composites and tap water.
A) Polyethylene Films when coated with pure 10%, 30% and 50% Carbowax-8000 solutions, offered no adhesion property even the films were left at room temperature conditions for a period of 24 hours.
B) Brown packaging paper and white paper was also coated with pure 10%, 30% and 50% Carbowax-8000 solutions and no adhesion was observed even if the films were left for a period of more than 24 hours.
C) Polyethylene films, whitepaper and brown paper coated with 2% of Carbowax encapsulated Nanochitin crystals showing good and prolonged adhesion over a period of time.

Self-adhesion was tested on big paper pieces as well as smaller, with similar results exhibited. The evidence shows tat hydrogen bonding occurs, and mechanical property data has been gathered.

### Properties of Materials, Including Biodegradability

The use of chitin nanowhiskers as a mechanical modifier or structural property enhancer for biodegradable material is promising. It will be noted that modifying the mechanical and structural properties of the below-described materials according to the methods set forth below did not all require the chitin to be encapsulated in a hydrophilic and/or lipophilic polymer wax. Studies involving chitin without such a wax, and studies involving chitin with such a wax, are both explained herein.

### Experimental Work for Recycled “Tim-Hortons” Coffee Cups Tray—Paper Based and Recycled Paper Based—and Nanochitin Whiskers at Each of Waste Grade, High Purity Grade, and Default Grade

First experimental work was done with the waste grade to see how it may be compatible and potentially how it may improve the mechanical properties of the recycled paper, such as stiffness.

| | Experimental work with | Experimental work with the |
|---|---|---|
| Experimental work with waste grade | default grade chitin | Ionic Chitin Whiskers (high |
| chitin nanowhiskers | nanowhiskers | purity grade) |
| Initially the Tim Horton tray was taken | Similar experimental was | Similar experimental was carried |
| as this is the best recycled material, | carried out with the default | out with the high purity grade |
| where the effect of chitin can be seen | grade using 2%, 5%, 7 and | using 2%, 5%, 7 and 10% in 200 |
| very effectively. | 10% in 200 gms. | gms. |
| The tray material was taken, without | Sample was only one small | Sample was only one small film |
| any weight measurement. The tray | film so not many tests were | so not many tests were done. |
| was broken into pieces and soaked in | done. | All the procedure was followed |
| water overnight, followed by its | All the procedure was | exactly as what was done in |
| filtration with a sieve. This soaked | followed exactly as what | column 1 with the waste grade |
| material was soaked again in vinegar | was done in column 1 with | chitin nanowhiskers. |
| (home/consumer grade) overnight. | the waste grade chitin | |
| The whole material was filtered the | nanowhiskers. | |
| next day, to take out the extra vinegar | | |
| smell. The soaked recycled paper was | | |
| then ground using a mixer at room | | |
| temperature, followed by the | | |
| preparing it into a paste form through | | |
| soaking in water. | | |
| We took 200 gms of soaked and | | |
| grounded recycled paper material in | | |
| different beakers and chitin waste | | |
| material (2 gms, 5 gms, 7 gms, 10 gms | | |
| and 20 gms) was added to these two | | |
| beakers separately, in order to | | |
| optimize the amount of chitin waste | | |
| for obtaining the required property. | | |
| Observation: - with 5% and 7% the | | |
| material was much better - that is, | | |
| more homogeneously resilient - with | | |
| waste chitin material, while with the | | |
| 20%, the final collected material was | | |
| very hard. | | |
| The experiment was also carried out | | |
| with the 2% as well, but it took a | | |
| longer time for drying and the | | |
| mechanicals were not good, in that the | | |
| films were very soggy with a retention | | |
| of water over a prolonged period. | | |
| Even after 72 hours, the film was still | | |
| wet with weak mechanical properties. | | |
| The sample was more brittle but not | | |
| well balanced though. | | |
| The mixed dough containing Tim | | |
| Horton's recycle paper + waste chitin | | |
| material was taken and drawn into the | | |
| small rectangular sheets, using | | |
| aluminum foils and drying then at 90° C. | | |
| for a period of 24 hours (i.e., drying | | |
| slowly). The sheets were left in the | | |
| oven at 60° C. overnight and then | | |
| finally collected as the dried samples. | | |
| (all experimental work was done at | | |
| room temperature lab conditions) | | |
| What was observed, generally | | |
| Surface of paper was a bit | | |
| rough, possibly simply due to lab scale | | |
| experimentation and is expected to be | | |
| smooth when the procedure was | | |
| followed, done normally at pulp and | | |
| paper industry. | | |
| Little bit of the smell of chitin | | |
| waste. We expect this can be latter | | |
| removed by addition of additives | | |
| offering the scents or perfumes, for | | |
| customer pleasure. | | |
| With the ionic chitin whiskers, | | |
| more chitin needed to be added, for | | |
| instance 5% with waste, 10% with | | |
| ionic and 7% with default grade. One | | |
| of the possible reasons could be | | |
| possible interaction between ionic | | |
| liquid, water and cellulose content. | | |
| Experimental work in water | | |
| and ethanol showed weight retention | | |
| in ethanol while in water, initially a bit | | |
| weight increases but then a loss in | | |
| weight. | | |

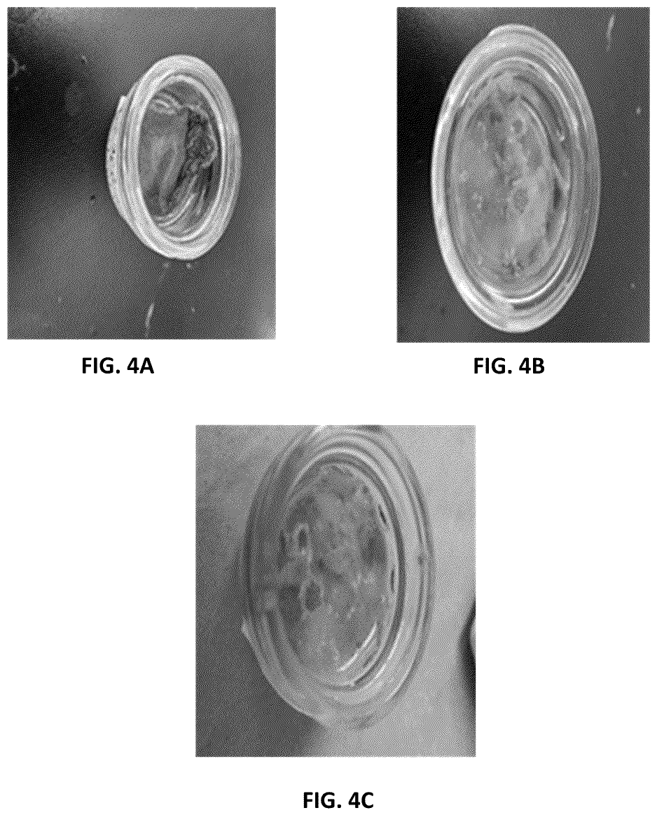

Water -immersion tests results
Water immersion tests were done on the samples after soaking them in either ethanol or water for a period
of 24 hours and 42 hours repetitively; that is three times each with default grade, high purity grade, and
waste grade) - at the time of this writing, this was done only with the waste material chitin, and not with
the default and ionic chitin whiskers.
Water (initial weight = 0.7 gms; weight after 24 hours = 1.0 gms and after complete drying at room
temperature; weight = 0.56 gms; weight after 42 hours = 0.56 gms; the weight showed a constant retention,
but same sample kept in water over a period of two weeks, showed the enzymatic -microbial degradation)
Ethanol (initial weight = 1.3 gms; weight after 24 hours = 1.3 gms and no change in mechanicals and
after drying the weight remains same after 42 hours was same = 1.3 gms.
Microbial Bio-degradation Behaviours (experiment was done with the waste chitin material as samples
for default and ionic was not enough to carry the work)
Tim-Horton's trays and chitin whisker samples kept at room temperature for evaluating the microbial
bio-degradation behavior.
FIG. 4A shows an experiment dish with a piece of paper only coated with Carbowax
FIG. 4B shows an experiment dish with a piece of paper having been coated with a chitin-Carbowax
coating for 27 days at room temperature, showing an amount of bio-degradation.
FIG. 4C shows the experiment dish of FIG. 4B with the piece of paper having been coated with the
chitin-Carbowax coating for 67 days at room temperature, showing a further amount of bio-degradation.

A similar experiment was also carried with recycled paper, in particular a Tim Hortons paper-based cup tray, in presence of chitin waste material and Carbowax PEG-8000 also. This bio-composite was observed to have similar toughness and structural properties, except the surface was much smoother and clearer than the paper sheets processed within chitin and without the Carbowax PEG-8000. The experimental work was carried by dissolving a Tim Hortons tray (29 gms) in 200 ml of water and 50 ml of vinegar, 10 gins of Carbowax PEG-8000 followed by blending into a uniform solution. The solution was kept overnight and then the whole blend mixture was kept in over at 100° C. for drying over a period of 8 hours. The material was use then making the sheets on small compression mold at 130° C. temperature. The films have similar structural and mechanical strength, with much smoother surface.

Based on the experiments and tests set forth above, it is proposed that various combinations of chitin and hydrophilic and/or lipophilic polymer wax may be deployed as useful products, additives, adhesive constituents and the like.

Based on the experiments and tests set forth above, it is also proposed that various combinations of chitin and cellulose-based material such as paper are contemplated, with or without Carbowax PEG-8000 or another Carbowax product, as are methods for producing reinforced cellulose-based products by distributing chitin generally uniformly throughout a cellulose-based slurry, molding the as-modified slurry into a desired shape (cup holder, as an example), and drying the molded slurry.

Various combinations of chitin and cellulose-based material such as paper are contemplated, where the cellulose-based material and the chitin are brought into contact while the cellulose-based material is not a slurry, but is instead in a desired shape but then while retaining the desired shape immersed in a liquid having chitin dispersed generally uniformly throughout, thereby to, when dried, form a reinforced product as compared with prior to the chitin interaction.

### Useful Products and Methods

A composite or mixture that includes chitin nanocrystals (i.e. nanochitin crystalline whiskers) dispersed in a hydrophilic and/or lipophilic polymer wax such as Carbowax PEG-8000, may be useful when used as described herein or in other ways for adhering surfaces of cellulose-based materials such as paper pieces together. This may be useful for manufacturing/assembly of packaging or other paper-based products such as for adhering a section of paper to another section of paper being folded towards itself for forming a paper-based bag or box using the paper. This may be useful for adhering a section of one kind of paper (such as brown paper) to a section of another kind of paper (such as white paper) for use, for example, in multi-layer packaging for food. Such a composite may alternatively be useful for repairing torn pages of a valuable book as an alternative to a more traditional adhesive such as a glue. Various practical applications for adhesion/connection based on what appears to be a chitin-cellulose binding mechanism set forth and explored in the present application may be determined. Qualitative observations during ad-hoc experiments of regular paper disintegrating over time when submerged in water, whereas chitin-enhanced paper appearing to remain mostly intact over the same time frame, may suggest additional applications.

Different grades of chitin, including those such as the waste grade referenced herein which contains some amorphous chitin, may be dispersed in a hydrophilic and/or lipophilic polymer wax to form a useful composite. Such chitin may be dispersed generally uniformly throughout the hydrophilic and/or lipophilic polymer wax. It may be that the amorphous chitin in the composite provides a slightly lower-grade (less adherence strength or longevity, for example) than with purer grades of chitin nanocrystals. However, like with chitin nanocrystals, such a composite may be useful for adhering surfaces of cellulose-based materials such as paper pieces together. This may be useful for manufacturing/assembly of packaging or other paper-based products such as for adhering a section of paper to another section of paper being folded towards itself for forming a paper-based bag or box using the paper. This may be useful for adhering a section of one kind of paper (such as brown paper) to a section of another kind of paper (such as white paper) for use, for example, in multi-layer packaging for food. Such a composite may alternatively be useful for repairing torn pages of a valuable book as an alternative to a more traditional adhesive such as a glue. Various practical applications for adhesion/connection based on what appears to be a chitin-cellulose binding mechanism set forth and explored in the present application may be determined.

In such compositions, use of the default grade may be used to provide a composite with substantially non-agglomerated chitin. Use of the waste grade may be used to provide a composite with units of substantially non-agglomerated chitin and units of agglomerated chitin with—perhaps depending on the process and the properties of the waste, more of the latter than the former.

The hydrophilic and/or lipophilic polymer wax of the composites referred to above may be in solid form, such as in flake or powder form, at room temperature. Alternatively, the hydrophilic and/or lipophilic polymer wax may be in liquid form.

The hydrophilic and/or lipophilic polymer wax may be a polyethylene glycol, such as Carbowax PEG-8000.

The composites and products referenced herein may be put to various uses. As described above, there is utility in using the composites referenced above as a binding agent (or “binder”), such as for binding two different cellulosic sheets such as paper together to adhere them based on chitin interactions. As such, a binding agent product could be sold that includes chitin dispersed in hydrophilic and/or lipophilic polymer wax, and may be regarded as a form of adhesive.

Various methods for forming a composite of chitin and hydrophilic and/or lipophilic polymer wax have been described.

Furthermore, various methods for forming cellulose-based products that include chitin and that, when dried, are self-supporting as products such as paper-based products (trays, containers, and the like), have been described. Such products may be formed with or without a hydrophilic and/or lipophilic polymer wax. More generally, a method for forming a self-supporting structure as described herein includes the steps of providing a cellulose-based slurry; distributing chitin generally uniformly throughout the cellulose-based slurry thereby to form a modified cellulose-based slurry; and molding the self-supporting structure using the modified cellulose-based slurry. It will be appreciated that the molding may involve a step of drying thereby to remove moisture and enable the rigidity of the self-supporting structure. In an example, prior to the distributing chitin step, the chitin may be encapsulated within a hydrophilic and/or lipophilic polymer wax thereby to form a chitin-wax composite, wherein the distributing chitin step comprises distributing the chitin-wax composite generally uniformly throughout the cellulose-based slurry.

It will be appreciated that, as observed herein, the modified cellulose-based slurry (i.e. containing the chitin) may provide rigidity and toughness advantages, such that a self-supporting structure such as that made using the cellulose-based slurry that is recycled may be suitable for use as a product after a greater number of recycling cycles than a counterpart product that was made in the same or similar way, but without the integration of chitin. It will be appreciated that the hydrophilic and/or lipophilic polymer wax may provide an aesthetic smoothness to a surface of a product made using the modified cellulose-based slurry, but that it is primarily the chitin itself and its binding with the cellulose material that appears to provide the increased rigidity and toughness advantages.

It will be appreciated that an existing self-supporting structure, such as a paper-based tray or a container, may not be formed originally using a modified cellulose-based slurry (ie., using chitin), but that it may thereafter be coated with a chitin composite in order to provide a shell or coating that improves rigidity and toughness, and may impart other properties to the exterior of the existing self-supporting structure. Such a coating may, should the self-supporting structure and its coating be recycled, mix further with the cellulose-based slurry into which the self-supporting structure is broken down during recycling. As such, what was once a coating may, during the recycling process, become more dispersed throughout the rest of the cellulose-based slurry thus forming the modified cellulose-based slurry from which a recycled self-supported structure may be formed. The recycled self-supporting structure may have more integral chitin-cellulose binding throughout than had the original self-supporting structure which was merely coated thus having chitin-cellulose binding only at its surface. Variations are possible.

### Clauses

Clause 1. A composite comprising chitin nanocrystals dispersed in a hydrophilic and/or lipophilic polymer wax.

Clause 2. A composite comprising chitin dispersed in a hydrophilic and/or lipophilic polymer wax.

Clause 3. The composite of clause 2, wherein the chitin is substantially non-agglomerated.

Clause 4. The composite of clause 2, wherein the chitin comprises units of substantially non-agglomerated chitin and units of agglomerated chitin.

Clause 5. The composite of clause 2, wherein the chitin is dispersed generally uniformly throughout the hydrophilic and/or lipophilic polymer wax.

Clause 6. The composite of clause 2, wherein the hydrophilic and/or lipophilic polymer wax is in solid form at room temperature.

Clause 7. The composite of clause 6, wherein the hydrophilic and/or lipophilic polymer wax is in flake or powder form.

Clause 8. The composite of clause 2, wherein the hydrophilic and/or lipophilic polymer wax is in liquid form.

Clause 9. The composite of clause 2, wherein the hydrophilic and/or lipophilic polymer wax is a polyethylene glycol.

Clause 10. Use of the composite of clause 2 as a binding agent.

Clause 11. A binding agent comprising chitin dispersed in a hydrophilic and/or lipophilic polymer wax.

Clause 12. A method of forming a composite, comprising the steps described herein.

Clause 13. A composite formed by the method of clause 12.

Clause 14. A mixture comprising chitin and at least one hydrophilic and/or lipophilic polymer wax.

Clause 15. The mixture of clause 14, wherein the mixture consists of chitin dispersed in the at least one hydrophilic and/or lipophilic polymer wax.

Clause 16. The mixture of clause 14, wherein the mixture comprises chitin dispersed in a solution comprising at least one hydrophilic and/or lipophilic polymer wax.

Clause 17. The mixture of clause 16, wherein the solution further comprises at least one of water and an ionic liquid.

Clause 18. The mixture of clause 15, wherein the at least one hydrophilic and/or lipophilic polymer wax is polyethylene glycol (“PEG”).

Clause 19. The mixture of clause 18, wherein the at least one hydrophilic and/or lipophilic polymer wax is Carbowax PEG-8000.

Clause 20. Use of the mixture of clause 14 as a binding agent.

Clause 21. An adhesive comprising chitin nanocrystals dispersed in a hydrophilic and/or lipophilic polymer wax.

Clause 22. A method of forming a self-supporting structure, the method comprising:
providing a cellulose-based slurry;
distributing chitin generally uniformly throughout the cellulose-based slurry thereby to form a modified cellulose-based slurry; and
molding the self-supporting structure using the modified cellulose-based slurry.

Clause 23. The method of clause 22, wherein prior to the distributing chitin step, the chitin is encapsulated within a hydrophilic and/or lipophilic polymer wax thereby to form a chitin-wax composite, wherein the distributing chitin step comprises distributing the chitin-wax composite generally uniformly throughout the cellulose-based slurry.

Clause 24. A self-supporting structure formed using the method of one of clauses 22 and 23.

Clause 25. A self-supporting structure comprising:
a molded and dried cellulose-based slurry having chitin generally uniformly distributed throughout.

Clause 26. The self-supporting structure of clause 25, wherein the self-supporting structure further comprises:
a hydrophilic and/or lipophilic polymer wax generally uniformly distributed throughout.

Clause 27. A self-supporting structure comprising chitin generally uniformly distributed about at least a surface of a cellulose-based structure.

Clause 28. The self-supporting structure of clause 27, wherein the chitin is generally uniformly distributed throughout the cellulose-based structure.

1. A composite comprising chitin nanocrystals dispersed in a hydrophilic and/or lipophilic polymer wax.

2. A composite comprising chitin dispersed in a hydrophilic and/or lipophilic polymer wax.

3. The composite of claim 2, wherein the chitin is substantially non-agglomerated.

4. The composite of claim 2, wherein the chitin comprises units of substantially non-agglomerated chitin and units of agglomerated chitin.

5. The composite of claim 2, wherein the chitin is dispersed generally uniformly throughout the hydrophilic and/or lipophilic polymer wax.

6. The composite of claim 2, wherein the hydrophilic and/or lipophilic polymer wax is in solid form at room temperature.

7. The composite of claim 6, wherein the hydrophilic and/or lipophilic polymer wax is in flake or powder form.

8. The composite of claim 2, wherein the hydrophilic and/or lipophilic polymer wax is in liquid form.

9. The composite of claim 2, wherein the hydrophilic and/or lipophilic polymer wax is a polyethylene glycol.

10. Use of the composite of claim 2 as a binding agent.

11. (canceled)

12. (canceled)

13. (canceled)

14. A mixture comprising chitin and at least one hydrophilic and/or lipophilic polymer wax.

15. The mixture of claim 14, wherein the mixture consists of chitin dispersed in the at least one hydrophilic and/or lipophilic polymer wax.

16. The mixture of claim 14, wherein the mixture comprises chitin dispersed in a solution comprising at least one hydrophilic and/or lipophilic polymer wax.

17. The mixture of claim 16, wherein the solution further comprises at least one of water and an ionic liquid.

18. The mixture of claim 15, wherein the at least one hydrophilic and/or lipophilic polymer wax is polyethylene glycol (“PEG”).

19. The mixture of claim 18, wherein the at least one hydrophilic and/or lipophilic polymer wax is Carbowax PEG-8000.

20. Use of the mixture of claim 14 as a binding agent.

21-28. (canceled)
